(19) United States
(12) Patent Application Publication
(10) Pub. No.: US 2005/0027553 A1
(43) Pub. Date: Feb. 3, 2005

(54) Semi-custom furniture design system and apparatus

(76) Inventor: Vanessa J. Samet, New York, NY (US)

Correspondence Address: EVELYN M. MARSHALL, ESQUIRE, 679 PLEASANT STREET, PAXTON, MA, 01612, US

(21) Appl. No.: 10/871,325

(22) Filed: Jun. 19, 2004

Related U.S. Application Data
(60) Provisional application No. 60/480,019, filed on Jun. 19, 2003.

(51) Int. Cl. G06F 17/60; A47C 7/00

(52) U.S. Cl. 705/1; 705/26

(57) ABSTRACT

A novel approach to furniture design has now been developed, thus providing furniture consumers with an improved method of customizing, redesigning and purchasing furniture. The present invention uses the Design-It-Yourself™ system to assist the purchaser in designing a more customized and more affordable piece of semi-custom furniture. The present invention also uses the Design-It-Yourself™ system to assist the purchaser in choosing alternative structural and design elements for a previously designed piece of furniture to modify the design of said piece of furniture. By practicing the disclosed invention, the furniture consumer will now enjoy a method of furniture design that allows the consumer to design a piece of furniture in the store (real, virtual, catalogue, or otherwise) where said method lets the consumer choose structural and design elements based on design and associated cost, and allows for the future modification of said designed furniture. The advantages of using the present invention include: semi-custom designed furniture at an affordable cost, future alterability of the designed furniture piece and the availability of customer service assistance in the design of said furniture.

### CROSS-REFERENCE TO RELATED APPLICATIONS

This application depends from provisional application Ser. No. 60/480,019, filed Jun. 19, 2003, and provisional application Ser. No. 60/378,740, filed May 8, 2002. I incorporate said provisional applications by reference as fully set forth.

### STATEMENT REGARDING FEDERALLY SPONSORED RESEARCH AND DEVELOPMENT

This invention has been created without the sponsorship or funding of any federally sponsored research or development program.

### REFERENCE TO A “MICROFICHE APPENDIX”

Not Applicable

### BACKGROUND OF THE INVENTION

1. Field of the Invention

The present invention relates generally to furniture design, and more specifically to a semi-custom furniture design system and apparatus, where said system and apparatus incorporates interchangeable structural and design elements into the initial design of the furniture to allow for future alteration.

2. Prior Art

Furniture consumers are generally limited to single design furniture items. Furniture is generally either mass produced or custom made. Mass produced furniture generally limits the number of design choices a consumer can participate in and generally limits the design choices to the structural material type, i.e., type of wood, and/or fabric covering. Such limitation in design choices is a tradeoff to keep the furniture prices relatively affordable. Custom made furniture generally allows the purchaser much more freedom regarding design choices, but tends to be very expensive. Despite their many differences, both mass produced and custom made furniture have a limited life span from a design viewpoint. Although, both mass produced and custom made furniture may be reworked to vary in appearance, i.e., such as reupholstering fabric elements or refinishing wood elements, the reworking is typically at a great expense of time and/or money and/or effort. Unwanted furniture is typically discarded and replaced with a newer, more updated or aesthetically pleasing piece.

While furniture design systems have been developed for home and office furnishing, such types of furniture design systems are primarily do-it-yourself kits concerned with the interchangability of structural members from one type of furniture to another, i.e., from chairs to desks or beds to cabinets, or are do-it-yourself kits concerned with a one time design for a piece of furniture, i.e., cabinets. Said systems do not allow the consumer to design the furniture piece in the store (real, virtual (as may be found on the world wide web), catalogue or otherwise), so that the designed furniture piece is made to the consumer's specifications. Said systems also do not allow for a method of future modification of structural and design elements so that the consumer may redesign said designed furniture piece and easily change the structural and design elements for a newer, more updated or aesthetically pleasing appearance.

There is therefore a need in the art for a method of creating affordable semi-custom design furniture pieces having structural and design elements that can be easily interchanged, thus allowing the purchaser to subsequently modify the appearance of said furniture pieces and lengthen the design and utilitarian life span of said furniture pieces.

It is therefore a principal object of the present invention to provide a method of designing furniture that gives the consumer the freedom to choose structural and design elements.

A further object of the present invention is to provide a method of designing furniture that gives the consumer the freedom to choose structural and design elements based on associated cost.

A further object of the present invention is to provide a method of designing furniture such that said structural and design elements may be easily interchanged to modify the appearance of said furniture.

A further object of the present invention is to provide a method of designing furniture such that it can be implemented in a number of types of systems, from a simple manual system to electronic devices or computerized systems.

A further object of the present invention is to produce furniture items with interchangeable and replaceable structural and design elements.

With these and other objects in view, as will be apparent to those skilled in the art, the invention resides in the combination of parts set forth in the specification and covered by the claims appended hereto.

### BRIEF SUMMARY OF THE INVENTION

A novel approach to furniture design has now been developed, thus providing furniture consumers with an improved method of customizing, redesigning and purchasing furniture. The present invention uses the Design-It-Yourself™ system to assist the purchaser in designing a more customized and more affordable piece of semi-custom furniture. The present invention also uses the Design-It-Yourself™ system to assist the purchaser in choosing alternative structural and design elements for a previously designed piece of furniture to modify the design of said piece of furniture. By practicing the disclosed invention, the furniture consumer will now enjoy a method of furniture design that allows the consumer to design a piece of furniture in the store (real, virtual, catalogue, or otherwise) where said method lets the consumer choose structural and design elements based on design and associated cost, and allows for the future modification of said designed furniture. The advantages of using the present invention include: semi-custom designed furniture at an affordable cost, furniture alterability of the designed furniture piece and the availability of customer service assistance in the design of said furniture.

These and other objects, as will be apparent to those skilled in the art, along with advantages and features of the invention disclosed herein, will be made more apparent from the description, drawings and claims that follow.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings, in which:

FIG. 1 is a flow diagram depicting the principal steps in an embodiment of the method of the present invention;

FIG. 2 is a schematic view of an embodiment of a touch screen interface of an embodiment of a device used to start the Design-It-Yourself™ system and collect design and price information according to the present invention, depicting a screen showing structural and design elements and associated price information;

FIG. 3 is a schematic view of an embodiment of a touch screen interface of an embodiment of a device used in the Design-It-Yourself™ system to collect design and price information according to the present invention, depicting a screen showing structural and design elements and associated price information, overall design and associated pricing information, ordering information and order print screen;

FIG. 4 is a schematic view of an embodiment of a side chair of the present invention and embodiments of interchangeable structural and design elements;

FIG. 5 is an illustrative front perspective view of embodiments of systems constructed according to the present invention; and

FIG. 6 is a front perspective view illustrating embodiments of input devices.

### NUMBERING OF THE DRAWINGS

10. Design-It-Yourself™ System
10a. Design-It-Yourself™ Process Initial Step
10b. Furniture Type Decision Step
10c. Furniture Type Design Step
10d. Design Elements Choice Step
10e. Overall Design Review
10f. Ordering Step
10g. Order Print Out Step
10h. Payment and Delivery Step
10i. Design Change Step
10j. Design or Redesign Another Furniture Piece Step
10k. Exit Design-It-Yourself™ System
101. Browse Step
10m. Restart Design-It-Yourself™ System
10n. Select Complete Furniture Piece Step
12. Touch Screen Design-It-Yourself™ System
14. Design-It-Yourself™ Welcoming Screen
16. Design-It-Yourself™ Start Button
18. Design-It-Yourself™ Exit Button
20. Design-It-Yourself™ Back Button
22. Furniture Design Type Inquiry Screen
24. Furniture Style Type Inquiry Screen
26. Design Element Inquiry Screen
28. Design Review Screen
30. Add to Shopping Cart Button
32. Sample Finished Product
34. Cost Analysis
36. Continue with Order/Process Order Button
38. Design Another Button
40. Order Information Screen
42. Print Order Screen
44. Print Button
46. View Accessories/Other Products Button
48. Design-It-Yourself™ Browse Button
50. Design-It-Yourself™ Subtotal Indicator
52. Design-It-Yourself™ Next Button
53. Cursor
54. Chair
55. Frame
56. Back Structural Element
58. Base Structural Element
60. Leg
60a. Fluted Tapered Leg with Ball Foot Leg Type
60b. Cabriole (S-Shaped) Leg Ending in Claw and Ball Foot Leg Type
60c. Plain Tapered Leg Ending in Ball Foot Leg Type
60d. Straight Leg Ending in Carved Foot Leg Type
62. Finial
64. Back
66. Seat
68a. Floral Cover
68b. Striped Cover
68c. Patterned Cover
70. Finish Type
72. Connecting Means
74. Design Element Connecting Means
76. Base Construction Connecting Means
78. Card File
80. Catalogue
82. Ordering Sheet
84. Dedicated Palm Top Device
86. Fax Machine
88. Modem
90. Voice Activated System
92. Computer System
94. Display and Keyboard
96. Interactive Touch Screen
98. Personal Data Assistant (PDA)

### DETAILED DESCRIPTION OF THE INVENTION

In the broadest aspects, the present invention provides the skilled artisan with the analytical tools and technical know-how sufficient to make and use the disclosed invention. The present invention provides the consumer with a semi-custom furniture design system that is easy to use, that can be used in the store or from a remote location, and enables the consumer to design and redesign semi-custom furniture based on structural and design elements and their associated cost.

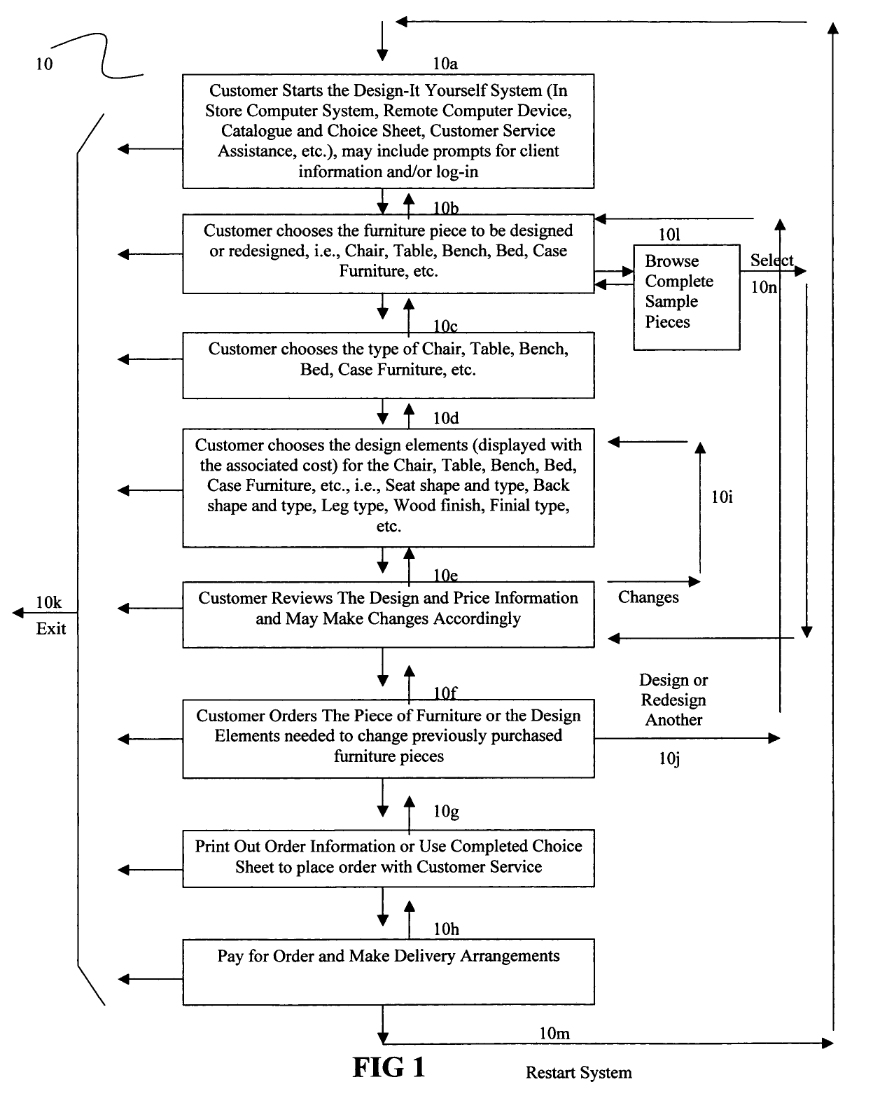

Referring first to FIG. 1, the Design-It-Yourself™ System of the present invention is generally indicated by the reference numeral 10, and comprises the steps of: 1) Initiating the Design-It-Yourself™ System, generally indicated by reference numeral 10a; 2) either Browsing through and/or Selecting completed sample furniture pieces, generally indicated by reference numerals 10l and 10n, respectively or Choosing a category of furniture to design, i.e., chairs, beds, cabinets, tables, etc., generally indicated by reference numeral 10b; 3) Choosing the type of chair, bed, cabinet, table, etc. frame, based on its design and associated cost, generally indicated by reference numeral 10c; 4) Choosing the design elements for the type of chair, bed, cabinet, table, etc., based on its design and associated cost, i.e., the seat shape, type and covering, the seat back shape, type and covering, finial type and material, seat leg type and material, frame material type and finish, etc., generally indicated by reference numeral 10d; 5) Reviewing the overall design and cost of the designed furniture piece, generally indicated by reference numeral 10e; 6) Making design and/or price consideration changes to the designed furniture piece if necessary, generally indicated by reference numeral 10i; 7) Ordering the furniture piece as a whole or elements thereof, generally indicated by reference numeral 10f; 8) Designing or redesigning another furniture piece if desired, generally indicated by reference numeral 10j; 9) Place completed order, generally indicated by reference numeral 10g; 10) Pay for order and make payment and delivery arrangements, generally indicated by reference numeral number 10h; and 11) either Exiting The Design-It-Yourself™ System, which may be also aborted at any time during the process, generally indicated by reference numeral number 10k or Restarting the Design-It-Yourself™ System, generally indicated by reference numeral 10m. FIG. 1 is submitted to illustrate the general flow of the Design-It-Yourself™ system. The Design-It-Yourself™ System illustrated in FIG. 1, however, is not limited to executing the steps in the order given. For example, the customer may move sequentially backward and forward between the previous and the next screen via back and next option keys, which are not illustrated in FIG. 1. The customer may initially browse for examples of completed furniture and order kits, as well as view rooms of completed furniture and order sets. Furthermore, customer information such as name and address and payment information may be input at the beginning of the process rather than the end, or not at all; a customer logon or identification card may be required prior to initiating the system or prior to ordering the piece of furniture; the customer may pick up where they left off in their previous design session; or provide payment information that was not available during the previous session. All methods of executing the Design-It-Yourself™ system known to those skilled in the art are contemplated for said invention. The system may utilize data storage and retrieval methods such as computer systems, or manual methods such as catalogue and order forms, or other methods known to those skilled in the art.

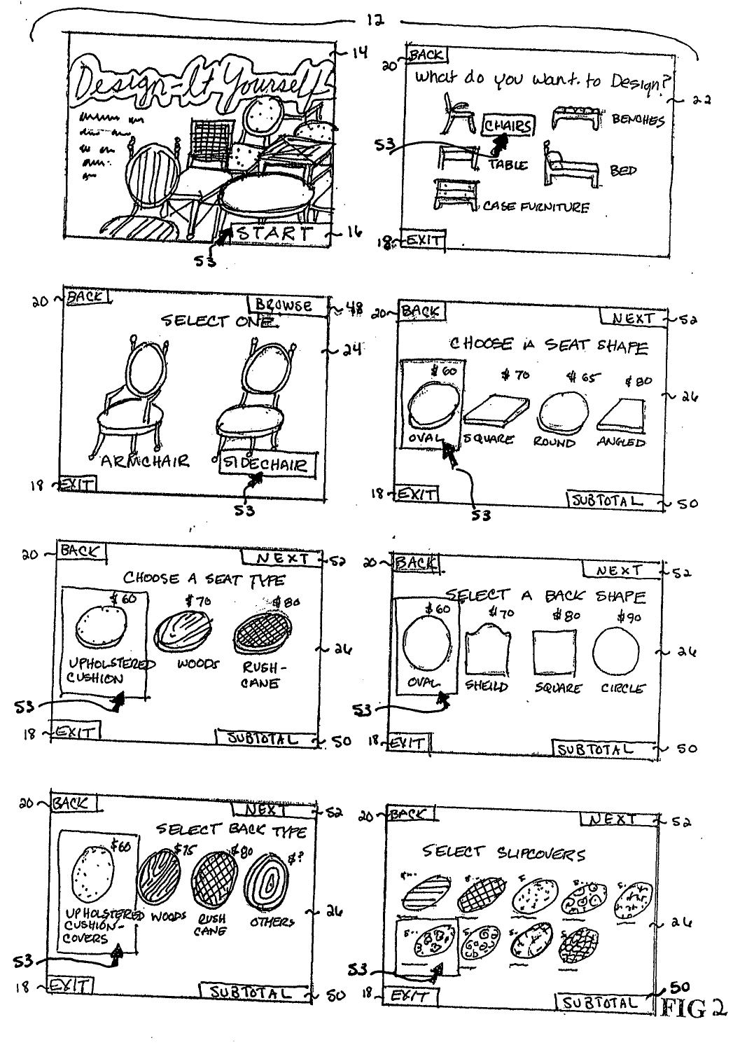

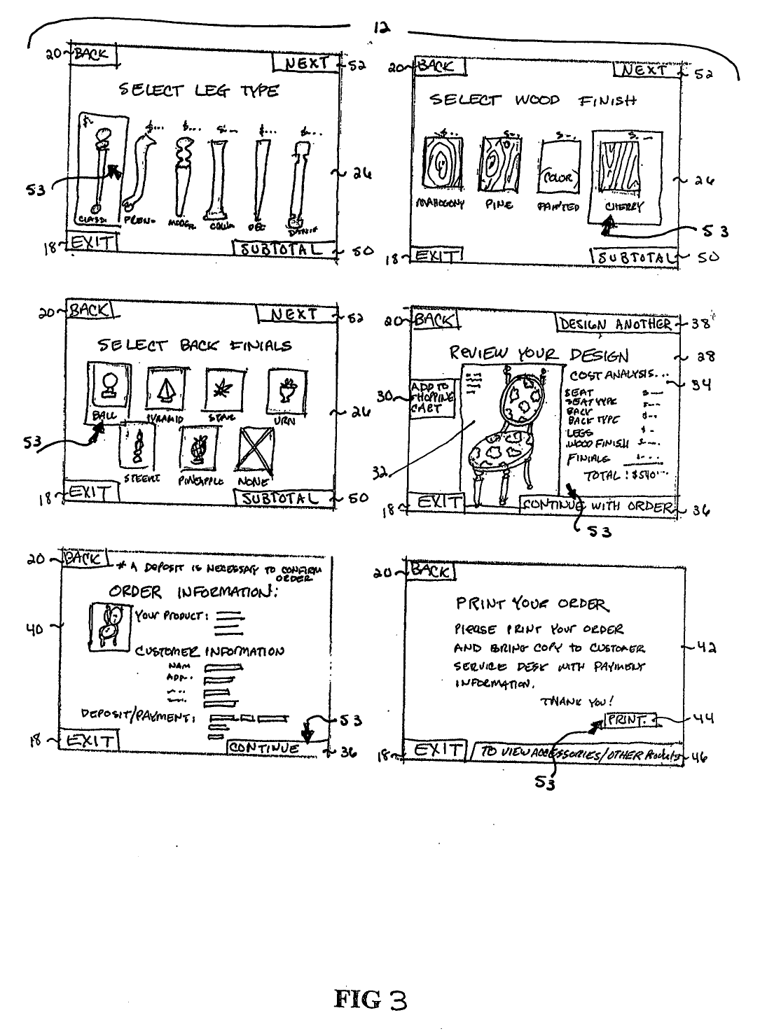

Now turning to FIG. 2 and FIG. 3, a preferred embodiment of the Design-It-Yourself™ system of the present invention is generally indicated by reference numeral 12. This configuration is related to chair design, but it will be clear to those skilled in the art that beds, cabinets, tables, case furniture, benches, or any other type of furniture could be selected. Said embodiment of the Design-It-Yourself™ system comprises executing the following steps on a touch screen computer system: 1) Viewing the Design-It-Yourself™ welcoming screen, generally indicated by reference numeral 14; 2) Touching the Design-It-Yourself™ Start button 16 on welcoming screen 14 to activate the Design-It-Yourself™ system 12; 3) Viewing the furniture type screen, generally indicated by reference numeral 22; 4) Touching the image of the type of furniture frame type to be designed, i.e., chair, table, case furniture, bench, bed, etc., on furniture type design screen 22; 5) Viewing the furniture style screen, generally indicated by reference numeral 24; 6) Either a) Touching the image of the style of the piece of furniture to be designed on furniture style screen 24, or b) Touching the Design-It-Yourself browse button, generally indicated by reference numeral 48, allowing the user to browse through designed furniture pieces for the type of furniture chosen in step 4. The user may choose a fully designed piece of furniture viewed in the browse mode and skip to step 10 below; 7) Viewing the design element screens, generally indicated by reference numerals 26; 8) Touching the desired design elements on design element screens 26, i.e., selecting design element shapes, sizes, coverings, materials, etc.; 9) Monitoring the Design-It-Yourself™ subtotal indicator, generally indicated by reference numeral 50; 10) Viewing the design review screen 28 to review the sample finished product 32 and cost analysis 34; 11) Either a) Touching the add to shopping cart button 30 to purchase the sample finished product 32, where such action will result with the screen remaining on design review screen 28, b) Touching the back button 20 to make changes to the designed furniture piece that will eventually return to design review screen 28, c) Touching the design another button 38 to design another piece of furniture, returning to step 3 above and furniture type screen 22, or d) Touching the continue with order/process order button 36; 12) Viewing the order information screen, generally indicated by reference numeral 40; 13) Entering and confirming order information including payment and customer information on order information screen 40; 14) Touching the continue with order button 36; 15) Viewing the print order screen, generally indicated by reference numeral 42; 16) Touching the print button 44, to print out the complete order; and 17) Either a) Touching the Design-It-Yourself™ exit button 18 to exit the system, b) Touching the Design-It-Yourself™ back button 20 to make changes, or c) Touching the view accessories/other products button 46 to view accessories and other products. At any stage in the process the user may back up using the Design-It-Yourself™ back button 20 to make desired changes. Choice selections will automatically bring the user forward and the user may also skip forward using the Design-It-Yourself™ next button 52. The user may exit the Design-It-Yourself™ system anytime by touching the Design-It-Yourself™ exit button 18. The system may also notify the user of the availability of particular structural elements and design elements so that if an element will not be available for a period of time the user will be notified during the design session. As previously stated above, the Design-It-Yourself™ System 10 and the preferred embodiment of the Design-It-Yourself™ System 12 illustrated in FIGS. 1, 2 and 3, are not limited to executing the steps in the order given. The customer may move sequentially backward and forward between the previous and the next screen via back and next option keys, which are not illustrated in FIG. 1. The customer may also use a mouse instead of a touch screen to make selections and the order may be directly submitted and paid for without human interaction. Furthermore, customer information such as name and address and payment information may be input at the beginning of the process rather than the end; a customer logon or identification card may be required prior to initiating the system or prior to ordering the piece of furniture; the customer may pick up where they left off in their previous design session; or provide payment information that was not available during the previous session. All methods of executing the Design-It-Yourself™ system known to those skilled in the art are contemplated for said invention including real stores, virtual stores, catalogue, etc. The system may utilize data storage and retrieval methods such as computer systems and manual methods, or those known to one skilled in the art. While the methods disclosed herein have been described and shown with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

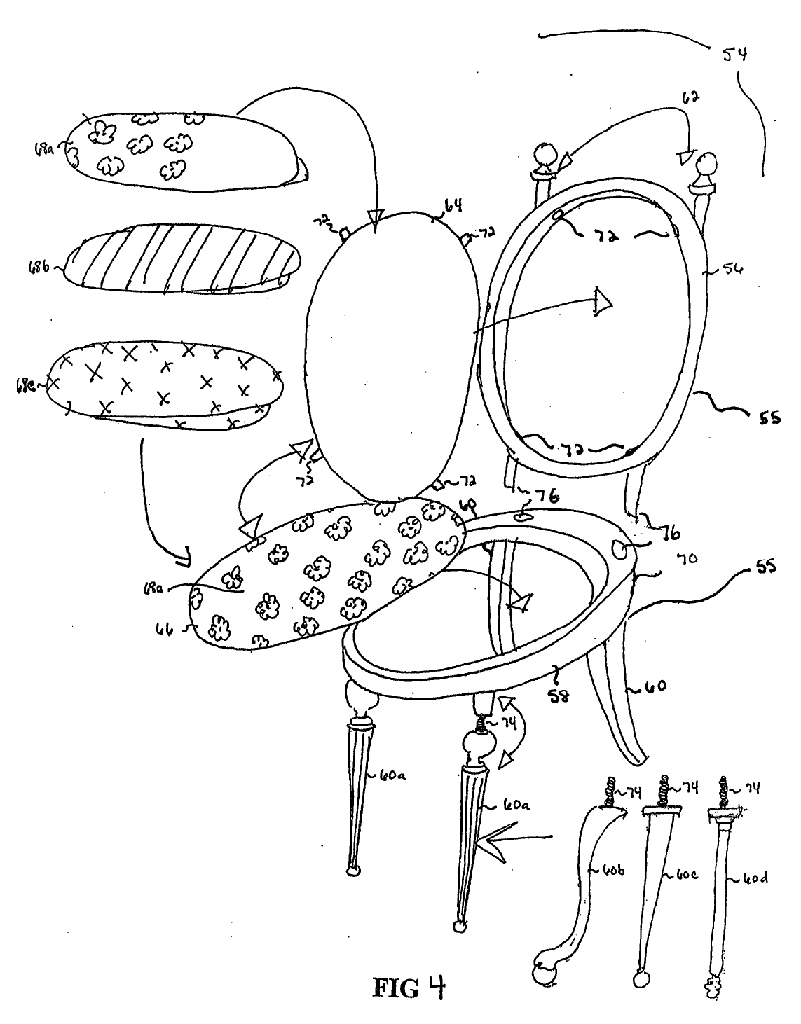

Turning now to FIG. 4, an embodiment of a furniture piece designed by the Design-It-Yourself™ system of the present invention is generally indicated by reference numeral 54, and is comprised of a frame, generally indicated by reference numeral 55. In further detail, said frame 55 is comprised of a back structural element, generally indicated by reference numeral 56, a base structural element, generally indicated by reference numeral 58, and selectively comprised of legs, generally indicated by reference numerals 60, 60a, 60b, 60c and 60d, finials, generally indicated by reference numeral 62, back, generally indicated by reference numeral 64, a seat, generally indicated by reference numeral 66, a cover, generally indicated by reference numerals 68a, 68b and 68c, the finish type, generally indicated by reference numeral 70, connecting means such as retractable push pins, nails, screws or those known by one of ordinary skill in the art, generally indicated by reference numeral 72, design element connecting means, generally indicated by reference numeral 74, and the base construction connecting means, generally indicated by reference numeral 76. Said back structural element 56 is connected to said base structural element 58 via base construction connecting means 76. Said base construction connecting means are of the type well known to those of ordinary skill in the art and may include, but are not limited to, nails, screws, glue and connecting methods known by one of ordinary skill in the art. Further, said leg types 60a, 60b, 60c and 60d are connected to said base structural element 58 via design element connecting means 74. Said design element connecting means 74 may be of, but are not limited to, the type that allow the chair base structural element 58 and leg type 60a, 60b, 60c and 60d to screw together such that said leg types 60a, 60b, 60c and 60d screw into said chair base structural element 58. Additionally, design element connecting means 74 include such connecting means known by those of ordinary skill in the art. Similarly, said finials 62 are connected to said back structural element 56 via design element connecting means 74 in the location shown. If a chair back is desired, said back 64 is connected to said back structural element 56 via connecting means 72. Other easily connecting and disconnecting means may also be used and those known by those of ordinary skill in the art, such as retractable push pins, screws, and other means may become available as technology advances. Said connecting means 72 secure said chair back 64 in place and allow for easy removal. Said covers 68a, 68b and 68c cover said seat 66 and said back 64 via methods well known by those of ordinary skill in the art such as zippers, buttons and tacks. Said seat 66 may also remain uncovered to expose wood or other decorative features. Said seat 66 is connected to base structural element 58 via a drop in type seat, connecting means 72, or methods well known by those of ordinary skill in the art. In this embodiment, the design of frame 55 will allow for a customer to easily change the appearance of chair 54 in the future. For example, the finials 62 and/or the back 64 may be substituted with alternate finials or backs, replaced or removed altogether for a different or newer appearance. The legs 60 and seat 66 may also be substituted or replaced for a different or newer appearance. The frame 55 may also be replaced. Said substitutability, removability and replacability is given as an example of how the Design-It Yourself system relates to chairs but is nor meant to limit said system to chair design. Said Design-It Yourself system relates to all types of furniture including, but not limited to, chairs, tables, desks, beds, cabinets, sofas and variations thereof.

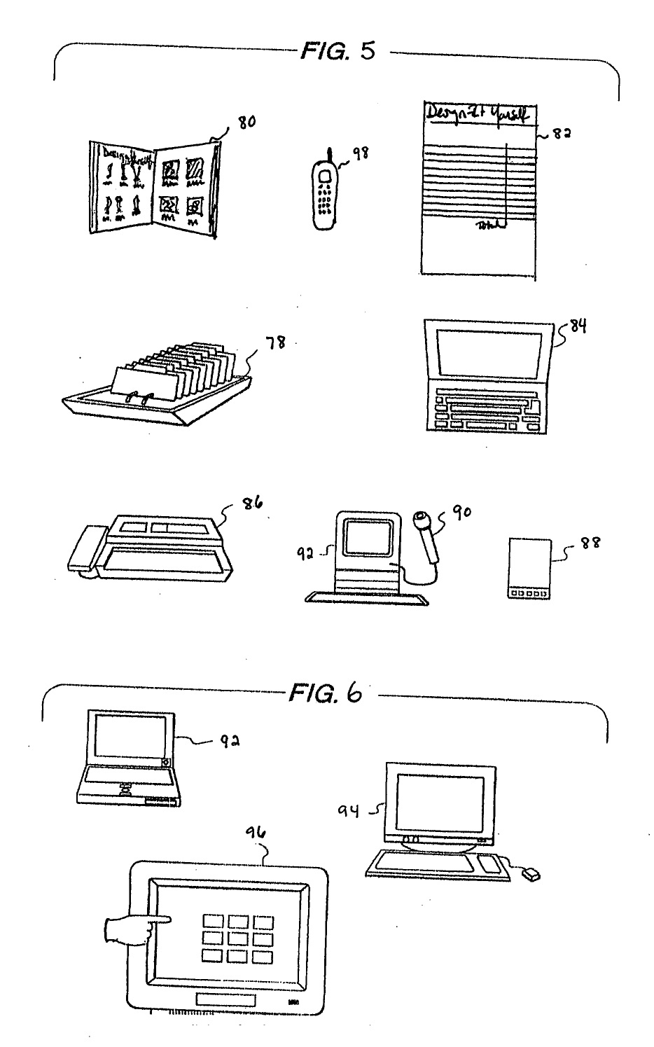

Turning now to FIG. 5, it will be apparent to those skilled in the art that the method and apparatus of the present invention can be implemented in a variety of ways, either at the store location or remotely. For example, in one embodiment, a manual system might use a card file 78 or catalogue 80, together with an instruction manual or ordering sheet 82 to go through the logic illustrated in FIGS. 1, 2 and 3. Alternatively, in other embodiments, an electronic device 84, such as a dedicated palmtop device similar to a pre-programmed electronic calculator could be used and is generally indicated by reference numeral 84. Either of these might be used in conjunction with a fax machine 86 or a modem 88 to convey the design information to a manufacturing system. Additionally, a voice-activated system or device 90 could be connected to a computer system 92 to implement the invention. Furthermore a Personal Data Assistant (PDA) 98 or other Internet connecting device could be used to utilize the Design-It-Yourself™ system. The Design-It-Yourself™ system may include other means of communication and data transfer when they become available as technology advances.

Turning now to FIG. 6, a preferred embodiment of the present invention using an interactive touch screen 96 is shown. A simpler display device 94 could also be used with a keyboard and/or mouse. In a preferred embodiment, the touch screen 96 is coupled to a system 92, including a keyboard and a mouse. The personal computer is programmed in any of the languages known by one of ordinary skill in the art suitable for touch screen interaction, to create the easy use of the interface and efficient data storage and retrieval. As will be apparent to those skilled in the art, any of a number of computer systems such as PDA's, laptops, mainframes, mini-computers, parallel processors, neural nets and so on could be used and will be apparent and used by one of ordinary skill in the art as technology advances. It is contemplated that the system may be implemented locally on said system 92 or in conjunction with the Internet.

The invention may be embodied in other specific forms without departing from the spirit or essential characteristics thereof. The foregoing embodiments are therefore to be considered in all respects illustrative rather than limiting of the invention described herein. The scope of the invention is thus indicated by the appended claims rather than by the foregoing description, and all changes which come within the meaning and range of equivalency of the claims are therefore intended to be embraced herein.

1. A method of designing and redesigning furniture comprising the steps of:
a. Initiating the apparatus for designing and redesigning furniture; and
b. Terminating said apparatus for designing and redesigning furniture.

2. The method of claim 1, further comprising the step of Viewing a set of interchangeable structural and/or design elements from a given set.

3. The method of claim 2, further comprising the step of Selecting a set of interchangeable structural and/or design elements from a given set.

4. The method of claim 3, where said selecting said set of said interchangeable structural and/or design elements may be selectively redesigned.

5. The method of claim 3, further comprising the step of Displaying the per element cost and subtotal associated with said set of said interchangeable structural and/or design elements.

6. The method of claim 3, further comprising Ordering said set of interchangeable structural and/or design elements.

7. The method of claim 3, further comprising Arranging for payment and delivery of said interchangeable structural and/or design elements.

8. The method of claim 3 further comprising:
a. Displaying the per element cost and subtotal associated with said set of said interchangeable structural and/or design elements;
b. Ordering said set of interchangeable structural and/or design elements; and
c. Arranging for payment and delivery of said interchangeable structural and/or design elements.

9. A data processing system for managing a furniture design method comprising the steps of:
a. Waiting for a customer to initiate said furniture design method;
b. Receiving input to initiate said furniture design method;
c. Displaying interchangeable structural and/or design elements; and
d. Waiting for said customer to choose said interchangeable structural and/or design elements or said data processing system will time out and return to Step a of claim 9.

10. The data processing system for managing a furniture design method of claim 9, further comprising the steps of:
a. Receiving inputs relative to said interchangeable structural and/or design elements; and
b. Storing said customer's inputs relative to said interchangeable structural and/or design elements.

11. The data processing system for managing a furniture design method of claim 9, further comprising the step of Waiting for said customer to order said interchangeable structural and/or design elements or said data processing system will time out and return to Step a of claim 9.

12. The data processing system for managing a furniture design method of claim 9, further comprising the steps of:
a. Displaying cost and subtotal information; and
b. Waiting for said customer to reselect said set of said interchangeable structural and/or design elements, order said of said interchangeable structural and/or design elements or said data processing system will time out and return to step a of claim 9;

13. The data processing system for managing a furniture design method of claim 9, further comprising the steps of:
a. Displaying a request for customer information; and
c. Waiting for said customer to input said information or said data processing system will time out and return to Step a of claim 9.

14. The data processing system for managing a furniture design method of claim 9, further comprising the steps of:
a. Receiving inputs relative to said interchangeable structural and/or design elements;
b. Storing said customer's inputs relative to said interchangeable structural and/or design elements;
c. Waiting for said customer to order said interchangeable structural and/or design elements or said data processing system will time out and return to Step a of claim 9;
d. Displaying cost and subtotal information;
e. Waiting for said customer to reselect said set of said interchangeable structural and/or design elements, order said of said interchangeable structural and/or design elements or said data processing system will time out and return to step a of claim 9;
f. Displaying a request for customer information; and
g. Waiting for said customer to input said information or said data processing system will time out and return to Step a of claim 9; and
h. Sending customer order information to appropriate departments to process order, pick, package and ship said order and record said order in relevant databases.

15. An apparatus for designing and redesigning furniture comprising:
1) A data processing system; and
2) A software program comprising a series of steps comprising:
a. Initiating the apparatus for designing and redesigning furniture;
b. Viewing a set of interchangeable structural and/or design elements from a given set;
c. Terminating said apparatus for designing and redesigning furniture.

16. The software program of claim 15, further comprising the step of Selecting a set of interchangeable structural and/or design elements from a given set.

17. The software program of claim 15, further comprising the steps of:
a. Selectively redesigning said set of said interchangeable structural and/or design elements may be selectively redesigned;
b. Displaying the per element cost and subtotal associated with said set of said interchangeable structural and/or design elements;
c. Ordering said set of interchangeable structural and/or design elements;
d. Arranging for payment and delivery of said interchangeable structural and/or design elements.

18. Semi-custom designed furniture comprising:
a. A frame;
b. Design elements; and
c. Connection Means, whereby said design elements are selectively, replaceably and interchangeably connected to said frame.

19. The semi custom designed furniture of claim 18, where said frame is selectively comprised of:
a. Back;
b. Base;
c. Panel;
d. Stretcher;
e. Top; and
f. Feet.
and said design elements are selectively comprised of:
g. Finials;
h. Legs;
i. Backs;
j. Seats;
k. Covers;
l. Panels;
m. Arms;
n. Tops;
o. Headboards;
p. Footboards;
q. Baseboards;
r. Feet;
S. Handles;
t. Pulls;
u. Base;
v. Platform;
w. Casters;
x. Shelves;
y. Upholstery;
z. Material Type; and
aa. Posts.

20. The semi custom designed furniture of claim 18, where said frame and said design elements are selectively comprised of:
a. Wood;
b. Metal;
c. Plastic;
d. Fabric; and
e. Specialty Materials.
